(19) United States
(12) Patent Application Publication
(10) Pub. No.: US 2006/0111048 A1
(43) Pub. Date: May 25, 2006

(54) Receiver circuit unit for radio controlled toys

(75) Inventor: Noriyuki Inomata, Nagareyama-city (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: Yukasha Co., LTD., Katsushika-ku (JP)

(21) Appl. No.: 11/284,831

(22) Filed: Nov. 23, 2005

(30) Foreign Application Priority Data
Nov. 25, 2004 (JP) 2004-372295

(51) Int. Cl. H04B 7/00

(52) U.S. Cl. 455/66.1; 446/456

(57) ABSTRACT

To obtain a receiver circuit unit for radio controlled toys configured such that the drive of a plurality of types of radio controlled toys can be controlled by a single transmitter by removably mounting the receiver circuit unit as a separate item. To provide a receiver circuit unit for radio controlled toys configured such that a receiver circuit unit mounting portion is provided in each of a plurality of types of radio controlled toys containing a drive mechanism, and a single receiver circuit unit is interchangeably and removably mounted on the receiver circuit unit mounting portion, whereby the drive of the plurality of types of radio controlled toys can be controlled by a single transmitter.

### BACKGROUND OF THE INVENTION

1. Field of the Invention

The present invention relates to a receiver circuit unit for radio controlled toys, and more particularly to a receiver circuit unit for radio controlled toys configured such that a receiver circuit unit can be freely mounted on a plurality of types of radio controlled toys to enable the plurality of types of radio controlled toys to be driven using a single transmitter and a single receiver circuit unit.

2. Description of the Related Art

Conventionally, radio controlled toys have been sold as a set of transmitter and driven body, robot or the like, but there are examples of driven bodies sold separately. This represents that users are increasingly demanding higher cost performance by operating a plurality of types of driven bodies by a single transmitter due to the fact that if there is only one operator, it is only necessary to have one transmitter.

However, in general products, the receiver circuit portion which dominates the manufacturing cost of the driven body is still incorporated in a state of being completely connected to the motive power unit of the driven body, so the cost of driven bodies remains high; even in the assembly type units described below, the receiver mechanism is completely connected within the driven body, and the receiver circuit unit does not have interchangeability as a separate item.

However, Examined Utility Model Publication No. H5-38796 described above relates to an assembly type vehicle which can be easily assembled targeted at a relatively low age group, and the receiver circuit unit does not particularly have interchangeability as a separate item.

Also, the object of Examined Patent Publication No. H5-69000 described above is to give users the enjoyment of completing the assemble of the product by themselves, so component assembly of the toy is made simpler than ever before, and also in this toy, the receiver circuit unit does not particularly have interchangeability as a separate item.

### SUMMARY OF THE INVENTION

In general radio controlled toys, the transmitter and receiver circuit portion are expensive. Therefore, if a user obtains just one set of a transmitter and receiver circuit portion, and if the receiver circuit can be easily installed in any other driven body, then by just purchasing a low cost driven body such as a driven toy or robot not having a built-in receiver circuit, the range of play activity can be dramatically expanded.

The present invention has been made as a result of diligent research into solving the problem in the prior art as described above. An object of the present invention is to provide a receiver circuit unit for radio controlled toys configured such that the drive of a plurality of types of radio controlled toys can be controlled by a single transmitter, by providing a receiver circuit unit mounting portion in each of the plurality of types of radio controlled toys containing a drive mechanism, and by interchangeably and removably mounting a single receiver circuit unit on the receiver circuit mounting portion.

According to the present invention, [the receiver circuit unit for radio controlled toys is] configured such that the drive of a plurality of types of radio controlled toys can be controlled by a single transmitter by providing a receiver circuit unit mounting portion in each of the plurality of types of radio controlled toys containing a drive mechanism, and by interchangeably and removably mounting a single receiver circuit unit on the receiver circuit mounting portion. Therefore, a plurality of types of driven bodies can be operated by a user with only a single set of a transmitter and receiver circuit unit, which has the effect of dramatically expanding the range of play activity.

### BRIEF DESCRIPTION OF THE DRAWINGS

FIG. 1 is a perspective view showing a receiver circuit unit for radio controlled toys according to the present invention applied to a radio controlled driven toy;

FIG. 2 is a perspective view of a transmitter; and

FIG. 3 is a perspective view showing a receiver circuit unit for radio controlled toys according to the present invention applied to a different type of radio controlled driven toy.

### DESCRIPTION OF THE PREFERRED EMBODIMENTS

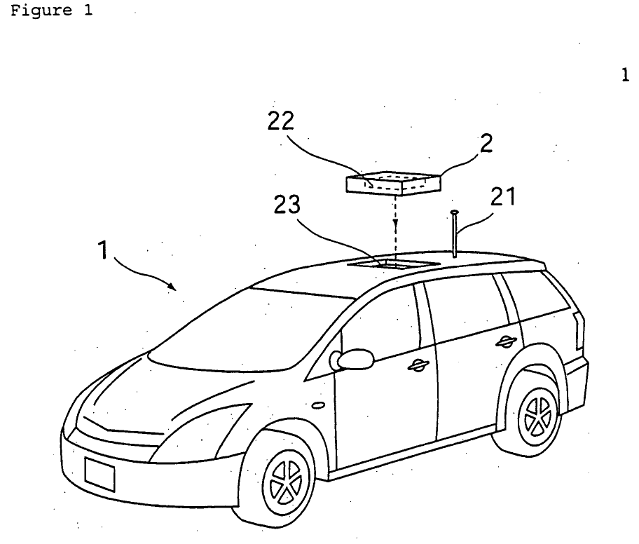

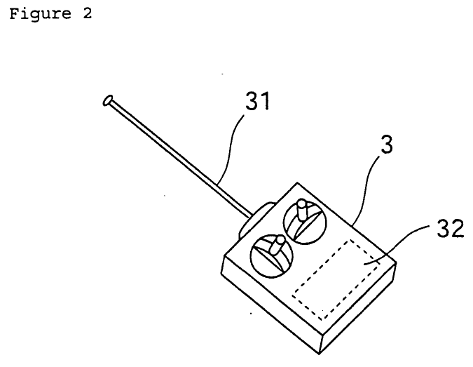

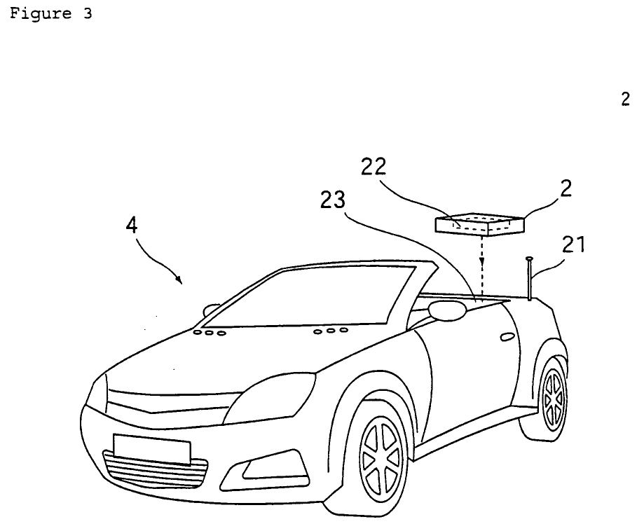

The best mode for carrying out the present invention is specifically explained in the following, based upon the drawings. In the drawings, FIG. 1 is a perspective view showing a receiver circuit unit for radio controlled toys according to the present invention applied to a radio controlled driven toy. FIG. 2 is a perspective view of a transmitter. FIG. 3 is a perspective view showing a receiver circuit unit for radio controlled toys according to the present invention applied to a different type of radio controlled driven toy.

As shown in FIG. 1, a receiver circuit unit mounting portion 23 is provided in a vehicle body 1, and a receiver circuit unit 2 is mounted on the receiver circuit unit mounting portion 23. A receiver circuit board 22 is incorporated in the receiver circuit unit 2 and is electrically connected to a receiving antenna 21 installed on the vehicle body 1 and a drive circuit (not shown) that drives a drive mechanism, when the receiver circuit unit 2 is mounted, and thereby the vehicle 1 can be operated by receiving radio waves transmitted from a transmitting antenna 31 by a transmitter circuit board 32 of a transmitter 3 shown in FIG. 2.

As shown in FIG. 3, a vehicle 4 different from the vehicle shown in FIG. 1 receives radio waves transmitted from the transmitting antenna 31 of the transmitter 3 by the transmitter circuit board 32 shown in FIG. 2, to operate the different type of vehicle 4 in the same manner as described above. The present embodiment is explained using a radio controlled driven vehicle as an example, but the driven body is not limited to a radio controlled driven vehicle, and the technical content of the present invention may of course be applied to toy driven bodies such as robots or dolls.

In other words, [the present invention] provides a receiver circuit unit for radio controlled toys configured such that the drive of a plurality of types of radio controlled toys can be controlled by a single transmitter, by providing a receiver circuit unit mounting portion in each of the plurality of types of radio controlled toys containing a drive mechanism, and by interchangeably and removably mounting a single receiver circuit unit on the receiver circuit mounting portion. Batteries (not shown) are naturally installed in the vehicles 1 and 4, and the transmitter 3.

What is claimed is:

1. A receiver circuit unit for radio controlled toys, wherein it is configured such that a receiver circuit unit mounting portion is provided in each of a plurality of types of radio controlled toys containing a drive mechanism, and a single receiver circuit unit is interchangeably and removably mounted on the receiver circuit unit mounting portion, whereby the drive of the plurality of types of radio controlled toys can be controlled by a single transmitter.
